(19) United States
(12) Patent Application Publication
(10) Pub. No.: US 2013/0214997 A1
(43) Pub. Date: Aug. 22, 2013

(54) MULTI-SCREEN DISPLAY APPARATUS

(71) Applicant: Naoki KANNO, Tokyo (JP)

(72) Inventor: Naoki KANNO, Tokyo (JP)

(21) Appl. No.: 13/712,691

(22) Filed: Dec. 12, 2012

(30) Foreign Application Priority Data
Feb. 16, 2012 (JP) 2012-031227

(51) Int. Cl. G06F 3/14

(52) U.S. Cl. CPC G06F 3/1423
USPC 345/1.3

(57) ABSTRACT

A multi-screen display apparatus includes image display apparatuses. A cooling device is thermally connected to semiconductor light sources that are respectively installed in image display apparatuses.

### BACKGROUND OF THE INVENTION

1. Field of the Invention

The present invention relates to a multi-screen display apparatus that displays an image on a multi-screen constituted by a plurality of screens.

2. Description of the Background Art

Conventionally, as respective light sources of a plurality of projection-type image display apparatuses that form a multi-screen display apparatus, discharge lamps have been widely used. In recent years, along with technical advances of LED's (Light Emitting Diodes), the light emission luminance of the LED has been increased so that the LED has become to withstand the use as a light source for the projection-type image display apparatus. In the following description, the projection-type image display apparatus is also referred to simply as an image display apparatus.

The light emission luminance of the LED is influenced by junction temperatures. For this reason, it is necessary to properly cool the LED serving as a light source. As cooling methods for the LED, there are a forceful air cooling system using a heat sink and a fan and a liquid cooling system in which a cooling liquid is forcefully circulated (see Patent Documents 1 and 2 (Japanese Patent Application Laid Open No. 2008-192579 and Japanese Patent No. 4654664).

In the forceful air cooling system or the liquid cooling system, a cooling process is carried out with a fan in each of image display apparatuses. Thus, in the multi-screen display apparatus constituted by a plurality of image display apparatuses also, the cooling process is carried out in each of the image display apparatuses.

However, in the case where the conventional forceful air cooling system, liquid cooling system or the like is used for cooling the multi-screen display apparatus, the following problems are raised.

The conventional multi-screen display apparatus constituted by a plurality of image display apparatuses needs to provide cooling mechanisms as many as the same number of the image display apparatuses. For example, the conventional multi-screen display apparatus constituted by four image display apparatuses requires four cooling mechanisms. As a result, a problem arises in which costs for cooling the multi-screen display apparatus are not sufficiently suppressed.

### SUMMARY OF THE INVENTION

(Object)

The object of the present invention is to provide a multi-screen display apparatus that can reduce costs for cooling.

(Constitution: Corresponding to claim 1)

A multi-screen display apparatus in accordance with one aspect of the present invention utilizes one or more cooling devices. The multi-screen display apparatus includes a plurality of image display apparatuses each having one of screens, and the plurality of image display apparatuses form a multi-screen by a plurality of the screens respectively installed in the plurality of image display apparatuses, each of the image display apparatuses including one of semiconductor light sources for emitting light for use in displaying an image on the multi-screen, and in this structure, one cooling device of the one or more cooling devices is thermally connected to a plurality of the semiconductor light sources respectively installed in the plurality of image display apparatuses so that the plurality of the semiconductor light sources are cooled.

In accordance with the present invention, the multi-screen display apparatus includes the plural image display apparatuses. The cooling device is thermally connected to a plurality of semiconductor light sources that are respectively installed in the plural image display apparatuses. Thus, it is not necessary to provide cooling devices as many as the same number of the image display apparatuses. As a result, it is possible to reduce costs for cooling the multi-screen display apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a structure of a multi-screen display apparatus in accordance with a preferred embodiment 1;

FIG. 2 is a view that explains a structure of a multi-screen;

FIG. 3 is a view schematically showing a state in which a cooling device is attached to the multi-screen display apparatus;

FIG. 4 is a block diagram showing a structure of an image display apparatus in accordance with the preferred embodiment 1;

FIG. 5 is a cross-sectional view showing a partial structure of the image display apparatus in accordance with the preferred embodiment 1;

FIG. 6 is a view showing an inner structure of the cooling device;

FIG. 7 is a view showing a structure of a multi-screen display apparatus 1000A in accordance with a modified example 1 of the preferred embodiment 1;

FIG. 8 is a view schematically showing a state in which a cooling device is attached to the multi-screen display apparatus;

FIG. 9 is a view showing a structure of an image display apparatus in accordance with the modified example 1 of the preferred embodiment 1; and

FIG. 10 is a view schematically showing a state in which a plurality of cooling devices are attached to the multi-screen display apparatus.

### DESCRIPTION OF THE PREFERRED EMBODIMENTS

Referring to drawings, the following description will explain a preferred embodiment of the present invention. In the following explanation, the same components are indicated by the same reference numerals. Those names and functions are the same. Therefore, the detailed explanation thereof will be sometimes omitted.

Moreover, dimensions, materials, shapes, relative layouts, etc. of respective components exemplified in the preferred embodiment are to be altered on demand depending on structures and various conditions of an apparatus to which the present invention is applied, and the present invention is not intended to be limited by those exemplary embodiments. Furthermore, the dimension of each of components in each of figures is sometimes different from its actual dimension.

### Preferred Embodiment 1

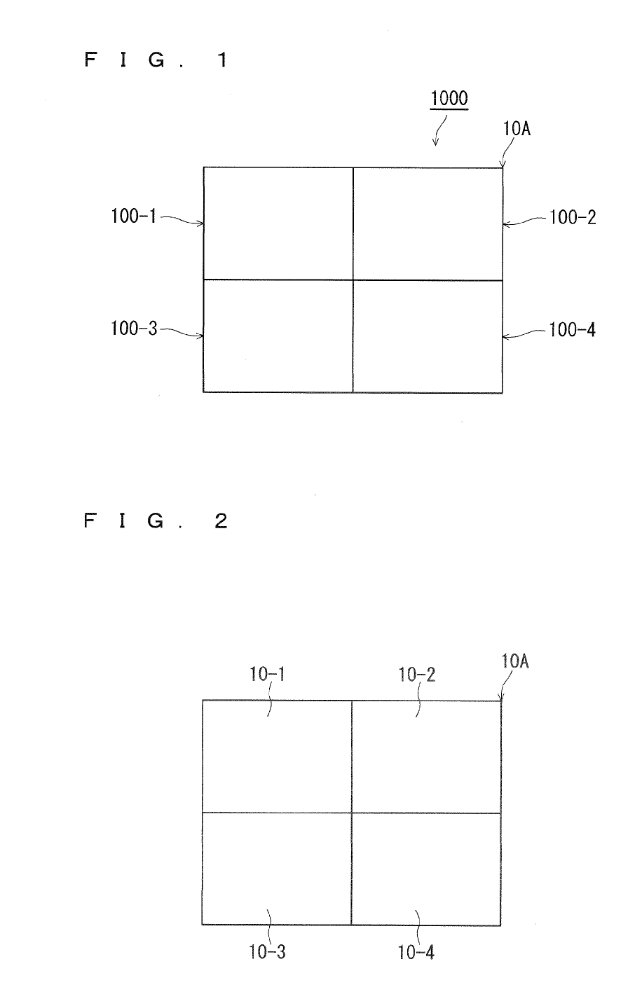

FIG. 1 is a view showing a structure of a multi-screen display apparatus 1000 in accordance with a preferred embodiment 1.

As shown in FIG. 1, the multi-screen display apparatus 1000 includes image display apparatuses 100-1, 100-2, 100-3 and 100-4. The detailed descriptions of the respective image display apparatuses 100-1, 100-2, 100-3 and 100-4 will be given later; however, the image display apparatuses 100-1, 100-2, 100-3 and 100-4 have the same structure. In the following description, each of the image display apparatuses 100-1, 100-2, 100-3 and 100-4 is also referred to simply as an image display apparatus 100.

The outside shape of each image display apparatus 100 is a rectangular parallelepiped. The multi-screen display apparatus 1000 is constituted by the four image display apparatuses 100 that are arranged in two rows and two stages.

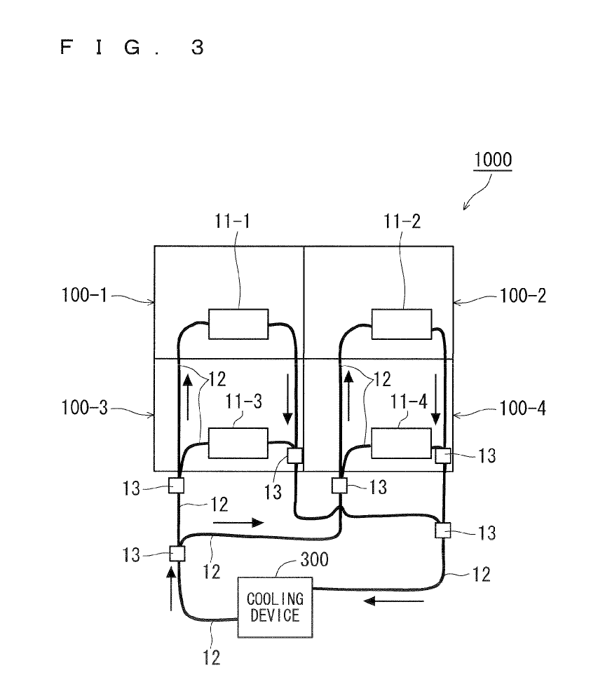

The image display apparatuses 100-1, 100-2, 100-3 and 100-4 respectively include screens 10-1, 10-2, 10-3 and 10-4 as shown in FIG. 2.

The multi-screen display apparatus 1000 includes a multi-screen 10A. As shown in FIG. 2, the multi-screen 10A forms a single screen constituted by screens 10-1, 10-2, 10-3 and 10-4 that are arranged in a matrix. In the following description, each of the screens 10-1, 10-2, 10-3 and 10-4 is also referred to simply as a screen 10. As described above, the multi-screen display apparatus 1000 includes the multi-screen 10A constituted by a plurality of screens 10 corresponding to the respective plurality of image display apparatuses 100.

Additionally, the number of the screens forming the multi-screen 10A is not limited by four, and may be set to 2, 3 or 5 or more. That is, the number of the image display apparatuses 100 forming the multi-screen display apparatus 1000 is not limited by four, and may be set to 2, 3 or 5 or more.

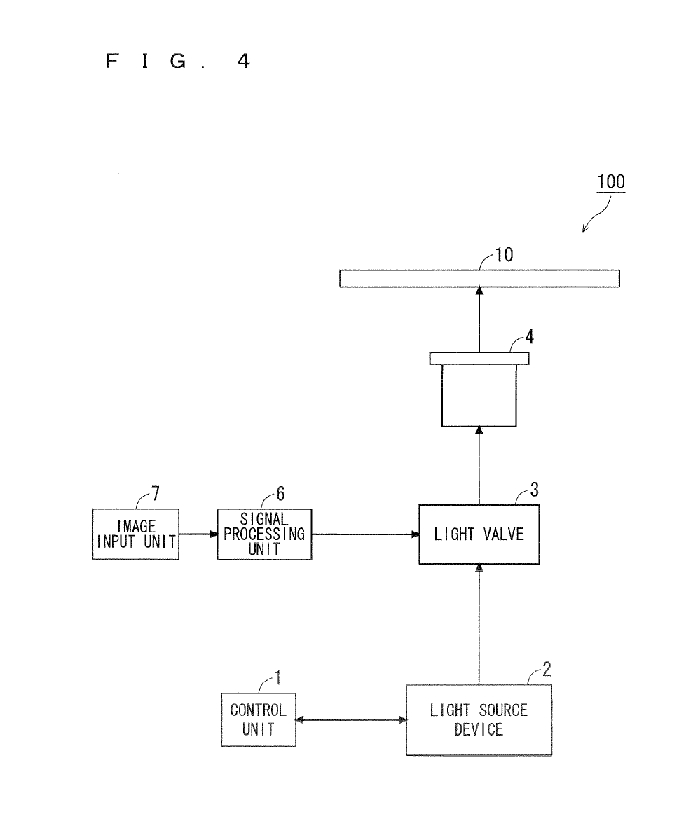

FIG. 3 is a view schematically showing a state in which a cooling device 300 is attached to the multi-screen display apparatus 1000. The multi-screen display apparatus 1000 carries out a cooling process on the multi-screen display apparatus 1000 by utilizing one or more units of the cooling devices 300.

The cooling device 300, which will be described in detail later, serves as a device for cooling the multi-screen display apparatus 1000 by using a cooling liquid. The cooling liquid refers to a liquid for use in cooling the multi-screen display apparatus 1000. The cooling device 300 cools elements that are thermally connected to the cooling device 300 itself.

The cooling device 300 is installed outside the multi-screen display apparatus 1000. That is, the multi-screen display apparatus 1000 does not include the cooling device 300. Additionally, the cooling device 300 may be installed inside the multi-screen display apparatus 1000.

As shown in FIG. 3, the image display apparatuses 100-1, 100-2, 100-3 and 100-4 are respectively provided with projection units 11-1, 11-2, 11-3 and 11-4. In the following description, each of the projection units 11-1, 11-2, 11-3 and 11-4 may also be referred to simply as a projection unit 11. The projection unit 11 projects images.

First, the following description will describe a structure of each of the image display apparatuses 100.

FIG. 4 is a block diagram showing a structure of the image display apparatus 100 in accordance with the preferred embodiment 1.

As shown in FIG. 4, each of the image display apparatuses 100 is provided with a control unit 1, a light source device 2, a light valve 3, a projection lens 4, a signal processing unit 6, an image input unit 7 and a screen 10.

The control unit 1 controls respective units (for example, a light source device 2) inside the image display apparatus 100.

The light source device 2 includes LED's (not shown). The light source device 2 emits light by utilizing the LED's. More specifically, the light source device 2 emits light for use in displaying an image on the multi-screen 10A. The light from the light source device 2 is projected onto the light valve 3.

The image input unit 7 receives an image signal from the outside, and transmits the corresponding image signal to the signal processing unit 6. The signal processing unit 6 carries out a signal (image) process, such as an image enlarging process and an image reducing process, on an image represented by the received image signal. Next, the signal processing unit 6 converts the image signal that has been signal-processed to a drive signal that can be processed by the light valve 3. Then, the signal processing unit 6 transmits the corresponding drive signal to the light valve 3.

The light valve 3 modulates an intensity of light emitted by the light source device 2 (a semiconductor light source to be described later). More specifically, the light valve 3 intensity-modulates light projected from the light source device 2 in accordance with the received drive signal, and projects the modulated light onto the screen 10 through the projection lens 4. Thus, an image is projected (displayed) on the screen 10.

The multi-screen display apparatus 1000 displays an image on the multi-screen 10A by the respective image display apparatuses 100 displaying images on the screens 10.

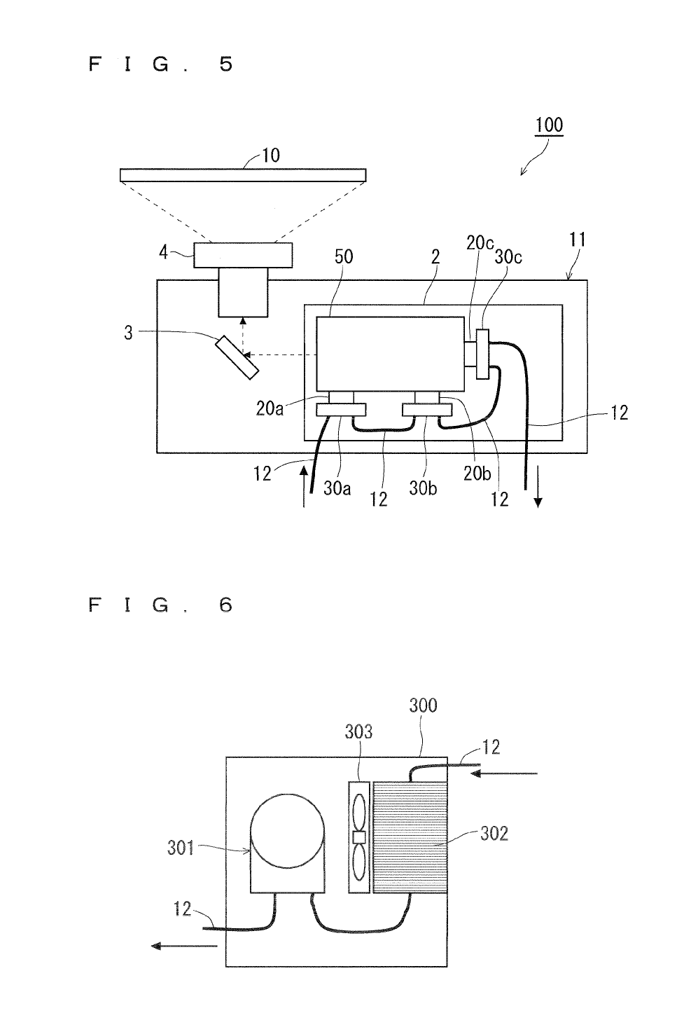

FIG. 5 is a cross-sectional view showing a partial structure of the image display apparatus 100 in accordance with the preferred embodiment 1. In FIG. 5, for simplicity of the figure, the size in the horizontal direction of the screen 10 is indicated as having a size smaller than the size in the horizontal direction of the projection unit 11. However, actually, the size in the horizontal direction of the screen 10 is larger than the size in the horizontal direction of the projection unit 11.

As shown in FIG. 5, the projection unit 11 of each of the image display apparatuses 100 includes the aforementioned light source device 2, light valve 3 and projection lens 4.

The light source device 2 includes semiconductor light sources 20a, 20b and 20c, and a housing 50. Additionally, the projection unit 11 is not provided with a cooling fan for use in cooling the light source device 2 (semiconductor light sources 20a, 20b, 20c, etc.).

The respective semiconductor light sources 20a, 20b and 20c are LED's. The semiconductor light sources 20a, 20b and 20c are attached to the housing 50. In the following description, each of the semiconductor light sources 20a, 20b and 20c is also referred to simply as a semiconductor light source 20. Each semiconductor light source 20 emits light for displaying an image on the multi-screen 10A.

In this case, the respective semiconductor light sources 20a, 20b and 20c are not limited by the LED's, but may be constituted by other elements that emit light. Moreover, the number of the semiconductor light sources 20 included by the light source device 2 is not limited by 3. The number of the semiconductor light sources 20 included by the light source 2 may be 1, 2 or 4 or more.

To the semiconductor light source 20a, a heat exchange jacket 30a is attached with a heat conductor material (not shown) interposed therebetween. The heat conductor material is prepared as, for example, grease. The heat conductor material is used for reducing contact thermal resistance. The semiconductor light source 20a is thermally joined to the heat exchange jacket 30a with the heat conductor material interposed therebetween.

To the semiconductor light source 20b, a heat exchange jacket 30b is attached with a heat conductor material (not shown) interposed therebetween. In the same manner as in the semiconductor light source 20a, the semiconductor light source 20b is thermally joined to the heat exchange jacket 30b with the heat conductor material interposed therebetween.

To the semiconductor light source 20c, a heat exchange jacket 30c is attached with a heat conductor material (not shown) interposed therebetween. In the same manner as in the semiconductor light source 20a, the semiconductor light source 20c is thermally joined to the heat exchange jacket 30c with the heat conductor material interposed therebetween.

The following description will describe a cooling structure in the multi-screen display apparatus 1000.

Referring again to FIG. 3, the projection units 11-1, 11-2, 11-3 and 11-4 are connected to the cooling device 300 by pipes 12 and branch pipes 13.

The pipes 12 are fluid pipes for allowing a cooling liquid to flow therein. The branch pipe 13 is used for sending the cooling liquid from one of the pipes 12 to two of the pipes 12.

For example, one end of the projection unit 11-1 is connected to the cooling device 300 by the pipe 12 through the two branch pipes 13. The other end of the projection unit 11-1 is connected to the cooling device 300 by the pipe 12 through the two branch pipes 13. Each of the projection units 11-2, 11-3 and 11-4 is also connected to the cooling device 300 in the same manner as in the projection unit 11-1.

The cooling device 300 the detailed description of which will be given later sends a cooling liquid to the respective image display apparatuses 100 by utilizing the pipes 12. Moreover, the cooling liquid, which is returned from the respective image display apparatuses 100 with its temperature being raised, is cooled, and the resulting cooling liquid is again sent to the respective image display apparatuses 100 through the pipes 12.

The following description will describe a connection structure between the pipes 12 and the projection unit 11.

Referring again to FIG. 5, the pipes 12 are connected to the respective heat exchange jackets 30a, 30b and 30c inside the light source devices 2 of the respective image display apparatuses 100. In this case, in FIG. 5, although the pipe 12 is indicated as if it was cut, one pipe 12 is thermally connected to the inside of each of the heat exchange jackets 30a, 30b and 30c in the actual structure. In the following description, each of the heat exchange jackets 30a, 30b and 30c is also referred to simply as a heat exchange jacket 30.

By using the above-mentioned structure, the cooling device 300 of one unit is thermally connected to the plurality of semiconductor light sources 20 (light source device 2 inside the projection unit 11) respectively installed in the plurality of image display apparatuses 100, and thus cools the plurality of semiconductor light sources 20 (light source device 2).

The following description will describe the cooling device 300.

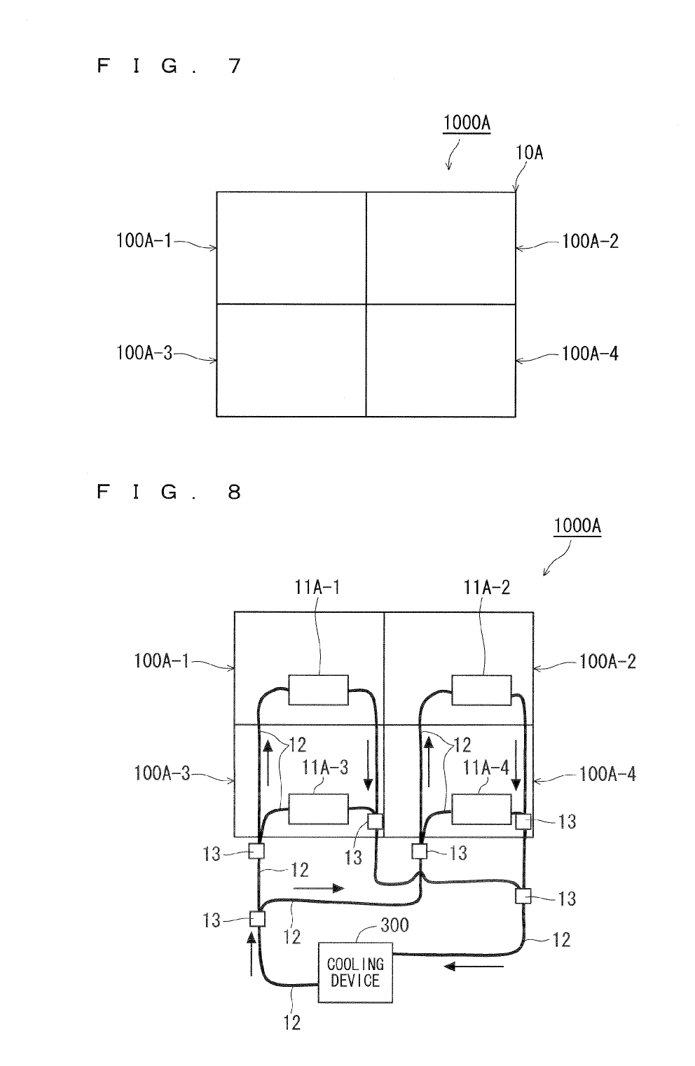

FIG. 6 is a view showing an inner structure of the cooling device 300.

The cooling device 300 includes a circulation pump 301, a radiator 302 and a cooling fan 303. The circulation pump 301 sends a cooling liquid by utilizing the pipes 12. The pipes 12 are allowed to penetrate through the inside of the radiator 302. The pipes 12 are thermally connected to the radiator 302. The cooling fan 303 forcefully cools the radiator 302 by using air.

The following description will explain a cooling process utilizing the cooling liquid. As shown in FIG. 3, the circulation pump 301 of the cooling device 300 sends the cooling liquid to the projection unit 11 of each of the image display apparatuses 100 by utilizing the pipes 12 and the branch pipes 13. That is, the cooling liquid, sent from the cooling device 300, is distributed by the branch pipes 13, and then sent to the projection unit 11 of each of the image display apparatuses 100. The cooling liquid exchanges heat with the respective semiconductor light sources 20 of the projection units 11 so that its temperature is raised, and is again returned to the cooling device 300 through the pipes 12.

The cooling liquid, which is returned from the respective image display apparatuses 100 with its temperature being raised, has its temperature lowered (cooled) by passing through the inside of the radiator 302.

The circulation pump 301 again sends the cooling liquid cooled by the radiator 302 to the projection unit 11 of each of the image display apparatuses 100. By the above-mentioned processes, the cooling liquid is allowed to circulate the inside of the image display apparatuses 100.

Here, the branch pipe 13 has such a structure as to prevent leakage of the cooling liquid upon removing from the connection with the pipes 12. Thus, even in the case where only one of the image display apparatuses 100 is taken out of the multi-screen display apparatus 1000 at the time of maintenance, etc. of the image display apparatuses 100, it is possible to carry out the corresponding operation smoothly.

Additionally, the present preferred embodiment has such a structure that branched processes of two stages are carried out on the cooling liquid between the cooling device 300 and the respective image display apparatuses 100. That is, two branch pipes 13 are installed between the cooling device 300 and each of the image display apparatuses 100. However, the present invention is not intended to be limited by this structure, and the branched process of one stage may be carried out on the cooling liquid.

The heat exchange in the light source device 2 is carried out in the following manner. As shown in FIG. 5, the cooling liquid is sucked into the projection unit 11 from the outside of the projection unit 11 by utilizing the pipes 12. Moreover, after heat exchange has been carried out thereon in the heat exchange jackets 30a, 30b and 30c, the resulting cooling liquid is again directed to the outside of the projection unit 11 by the pipes 12.

In this case, by taking the susceptibility to influences from temperature and the heating value of the LED's into account, the semiconductor light sources 20a, 20b and 20c are set in the following manner.

First, the semiconductor light source 20a is prepared as an LED that emits light with red color. Moreover, the semiconductor light source 20b is prepared as an LED that emits light with blue color. The semiconductor light source 20c is prepared as an LED that emits light with green color. In this case, the cooling liquid is allowed to pass through the inside of each of the heat exchange jackets 30a, 30b and 30c in the order of the heat exchange jackets 30a, 30b and 30c by the pipes 12. Thus, heat exchanging processes with the semiconductor light sources 20 corresponding to the respective heat exchange jackets 30 are carried out so that the cooling processes of the semiconductor light sources 20 (light source device 2) are carried out.

As described above, in accordance with the present preferred embodiment, the single cooling device 300 is thermally connected to the plurality of semiconductor light sources 20 (light source device 2 in each projection unit 11) that are respectively installed in the plurality of image display apparatuses 100, and cools the plurality of semiconductor light sources 20 (light source device 2). Thus, it is not necessary to install the cooling devices 300 as many as the same number of the image display apparatuses 100. For this reason, it is possible to reduce costs required for cooling the multi-screen display apparatus 1000.

Moreover, by collectively carrying out the cooling processes of the semiconductor light sources 20 (light source device 2) of the plurality of image display apparatuses 100, it is possible to reduce temperature deviations among the respective image display apparatuses 100, and consequently to easily carry out temperature controls on the semiconductor light sources.

In the conventional multi-screen display apparatus (hereinafter, referred to also as “multi-screen display apparatus J”), it is necessary to provide cooling mechanisms as many as the same number of the image display apparatuses. In the case where the liquid cooling process is applied to the cooling process of the semiconductor light source, the service life of a pump that is key to the cooling processes has not matched with the service life of the semiconductor light source, with the result that before reaching the life of the semiconductor light source, the pump tends to break down.

For this reason, in the case where each of the image display apparatuses forming the multi-screen display apparatus J has a cooling mechanism, the probability that the pump breaks down becomes higher as the number of the image display apparatuses forming the multi-screen display apparatus J becomes larger.

Moreover, in the multi-screen display apparatus J, each of the image display apparatuses has a fan for cooling a cooling liquid. For this reason, upon operating the multi-screen display apparatus J, all the fans of the image display apparatuses are operated. Consequently, much power is consumed in the multi-screen display apparatus J, with high noise being generated.

For this reason, in the multi-screen display apparatus 1000 in accordance with the present preferred embodiment, a structure is prepared in which a cooling process of each of the semiconductor light sources 20 (light source device 2) of the plurality of image display apparatuses 100 is carried out by a single cooling device 300. In other words, the structure makes it possible to collectively carry out cooling processes of the plurality of image display apparatuses 100. Additionally, each of the image display apparatuses 100 does not have a cooling mechanism for the semiconductor light sources 20 (light source device 2).

This structure makes it possible to reduce the number of pumps and fans required for cooling in comparison with that of the cooling structure of the multi-screen display apparatus J. Thus, the present preferred embodiment makes it possible to reduce the probability of failures in the pump to be used for cooling the multi-screen display apparatus 1000. Moreover, noise in the multi-screen display apparatus 1000 can be reduced, and power consumption thereof is also reduced.

Moreover, the cooling device 300 is installed outside of each image display apparatus 100. Therefore, waste heat of the light source 20 (light source device 2) can be carried out outside the image display apparatus 100. Consequently, the heat radiation of the image display apparatus 100 itself can be reduced. As a result, it is possible to reduce a temperature rise of the image display apparatus 100 on the upper stage of the multi-screen display apparatus 1000.

Moreover, in the present preferred embodiment, it is not necessary to attach a cooling fan for cooling liquid to each of the image display apparatuses 100. For this reason, the total number of the fans to be used can be reduced. Consequently, noise can be reduced. Moreover, since the cooling process of each of the semiconductor light sources 20 (light source device 2) of each of the image display apparatuses 100 in the multi-screen display apparatus 1000 is carried out by using a single cooling device 300, this structure is also effective for energy saving and cost reduction.

Since the cooling process of each of the semiconductor light sources of the plurality of image display apparatuses is carried out by using a single cooling device 300, the access to the corresponding cooling device 300 is easily carried out so that time-consuming maintenance tasks can be reduced. Moreover, since the temperature controls of the semiconductor light sources 20 (light source device 2) can be collectively carried out, those processes can be easily carried out in comparison with conventional temperature controls that need to be carried out for each of the image display apparatuses.

Additionally, in the present preferred embodiment, the structure utilizing a single cooling device 300 is adopted; however, the present invention is not limited by this structure. Another structure may be used in which cooling devices 300 the number (integer of 1 or more) of which is less than the number of the image display apparatus forming the multi-screen display apparatus 1000 are utilized.

Additionally, the cooling device 300 of the present preferred embodiment has a capacity of cooling four image display apparatuses 100 in its maximum level. When the number of the image display apparatuses 100 forming the multi-screen display apparatus 1000 is varied, the number of the image display apparatuses 100 to be connected to the single cooling device 300 is also varied. Therefore, the cooling capability of the cooling device 300 may be altered depending on the number of the image display apparatuses 100 to be connected to the cooling device 300. With this arrangement, the power consumption required for cooling can be reduced and noise can also be reduced.

### Modified Example 1 of Preferred Embodiment 1

In the preferred embodiment 1, only the semiconductor light sources 20 of each image display apparatus 100 are cooled. In a modified example 1 of the present preferred embodiment, in addition to the semiconductor light sources 20, the light valve 3 is also simultaneously cooled.

FIG. 7 is a view showing a structure of a multi-screen display apparatus 1000A in accordance with the modified example 1 of the preferred embodiment 1.

As shown in FIG. 7, a multi-screen display apparatus 1000A includes image display apparatuses 100A-1, 100A-2, 100A-3 and 100A-4. The respective image display apparatuses 100A-1, 100A-2, 100A-3 and 100A-4 have the same structure.

The image display apparatuses 100A-1, 100A-2, 100A-3 and 100A-4 respectively include screens 10-1, 10-2, 10-3 and 10-4 as shown in FIG. 2. In the following description, each of the image display apparatuses 100A-1, 100A-2, 100A-3 and 100A-4 is also referred to simply as an image display apparatus 100A.

In the same manner as in the multi-screen display apparatus 1000, the multi-screen display apparatus 1000A includes a multi-screen 10A.

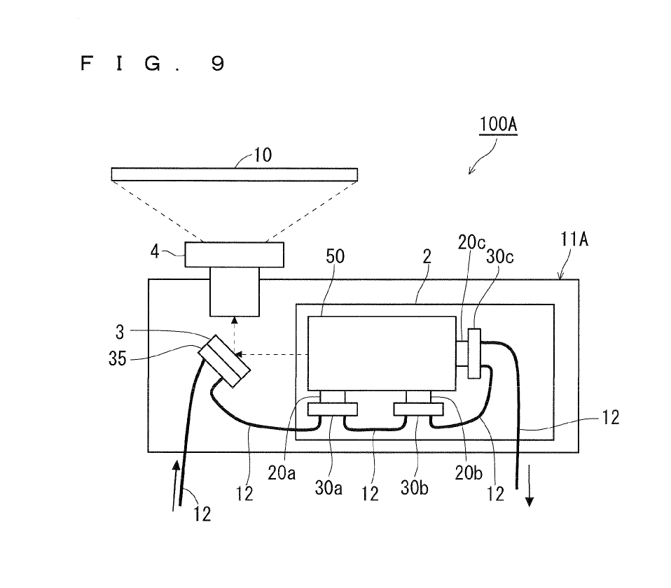

FIG. 8 is a view schematically showing a state in which a cooling device 300 is attached to the multi-screen display apparatus 1000A.

As shown in FIG. 8, the image display apparatuses 100A-1, 100A-2, 100A-3 and 100A-4 respectively have projection units 11A-1, 11A-2, 11A-3 and 11A-4. In the following description, each of the projection units 11A-1, 11A-2, 11A-3 and 11A-4 is referred to also as a projection unit 11A.

The projection unit 11A has the same structure as that of the projection unit 11.

Since the connection state between the cooling device 300 and each projection unit 11A is the same as the connection state between the cooling device 300 and each projection unit 11 of FIG. 3, the detailed description thereof is not repeated.

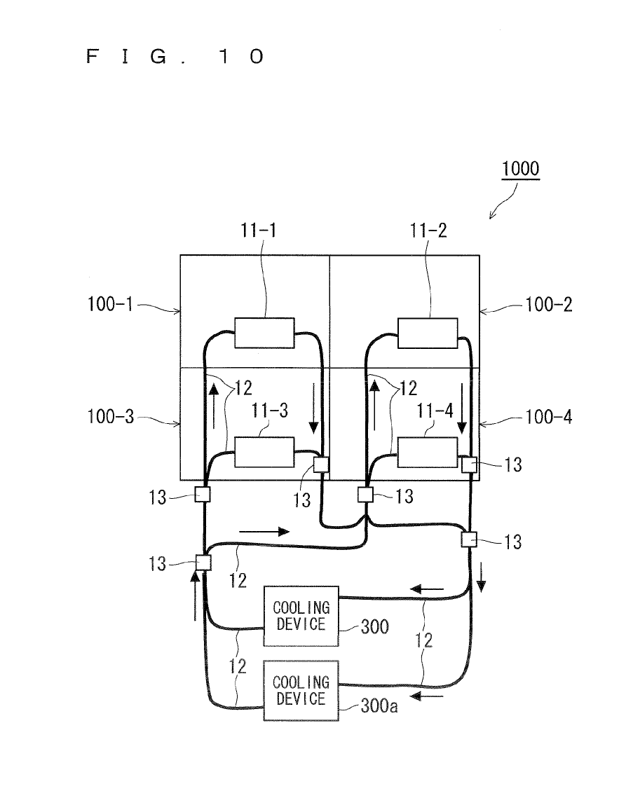

FIG. 9 is a view showing a structure of the image display apparatus 100A in accordance with the modified example 1 of the preferred embodiment 1. In comparison with the image display apparatus 100 shown in FIG. 5, the image display apparatus 100A differs therefrom in that in place of the projection unit 11, the projection unit 11A is installed therein. Since the other structures of the image display apparatus 100A are the same as those of the image display apparatus 100, the detailed description thereof is not repeated.

In comparison with the projection unit 11 of FIG. 5, the projection unit 11A differs therefrom in that a heat receiving block 35 is further included therein. Since the other structures of the projection unit 11A are the same as those of the projection unit 11, the detailed description thereof is not repeated.

The heat receiving block 35 is a heat conductor for use in conducting heat. The heat receiving block 35 is thermally connected to a rear surface of the light valve 3. Moreover, a pipe 12 is thermally connected to the inside of the heat receiving block 35. By the above-mentioned structure, the single cooling device 300 is thermally connected to the plurality of light valves 3 that are respectively installed in the plurality of image display apparatuses 100A.

Additionally, one pipe 12 is thermally connected to the heat receiving block 35 and the heat exchange jackets 30a, 30b and 30c.

In the image display apparatus 100A having the above-mentioned structure, first, a cooling liquid that is sent from the cooling device 300 through the pipe 12 is allowed to pass through the inside of the heat receiving block 35. Thus, a heat exchanging process is carried out with the light valve 3 that is connected to the heat receiving block 35 so that the light valve 3 is cooled.

Moreover, in the same manner as in the preferred embodiment 1, the cooling liquid is allowed to pass through the heat exchange jackets 30a, 30b and 30c in the order of the heat exchange jackets 30a, 30b and 30c by the pipe 12. Thus, heat exchange is carried out with the semiconductor light sources 20 that correspond to the respective heat exchange jackets 30 so that the semiconductor light sources 20 (light source device 2) are cooled. Then, the cooling liquid is again returned to the cooling device 300.

As described above, in accordance with the structure of the modified example 1 of the preferred embodiment 1, in addition to the plurality of semiconductor light sources 20 (light source device 2), the cooling device 300 is further thermally connected to the plurality of light valves 3 so that the plurality of light valves 3 are cooled. With this structure, in addition to the plurality of semiconductor light sources 20 (light source device 2), the plurality of light valves 3 can also be cooled simultaneously. Moreover, the modified example 1 of the preferred embodiment 1 provides the same effects as those of the preferred embodiment 1. That is, it is possible to reduce costs required for cooling the multi-screen display apparatus 1000A.

In comparison with a conventional configuration having a cooling structure for semiconductor light sources and light valves in each of image display apparatuses, the structure of the modified example 1 of the preferred embodiment 1 makes it possible to reduce the number of pumps and cooling fans. As a result, it becomes possible to reduce the probability that the pump breaks down in the multi-screen display apparatus 1000A.

By reducing the number of the cooling fans, it is possible to reduce noise in the multi-screen display apparatus 1000A.

In the modified example 1 of the present preferred embodiment 1, a structure is prepared in which waste heat of the semiconductor light sources 20 (light source device 2) and the light valves 3 is sent from the respective image display apparatuses 100A to the cooling device 300 externally located. With this structure, the heating value of the image display apparatus 100A can be reduced. As a result, a temperature rise of the other image display apparatuses in the multi-screen display apparatus 1000A can be reduced.

### Modified Example 2 of Preferred Embodiment 1

In the preferred embodiment 1, the single cooling device is used for cooling a multi-screen display apparatus. In a modified example 2 of the present preferred embodiment, a structure is explained in which a plurality of cooling devices are used. The multi-screen display apparatus in the modified example 2 of the present preferred embodiment corresponds to the multi-screen display apparatus 1000 of the preferred embodiment 1.

FIG. 10 is a view schematically showing a state in which cooling devices 300 and 300a are attached to the multi-screen display apparatus 1000. That is, the multi-screen display apparatus 1000 in accordance with the modified example 2 of the present preferred embodiment utilizes a plurality of cooling devices.

Since the connection state between the projection unit 11 of each of the image display apparatuses 100 and the cooling device 300 in the multi-screen display apparatus 1000 is the same as that shown in FIG. 3, the detailed explanation is not repeated.

In the present preferred embodiment, to the two branch pipes 13 connected to the cooling device 300, a cooling device 300a is further connected. That is, each of the cooling devices 300 and 300a is thermally connected to a plurality of semiconductor light sources 20 (light source device 2 inside the projection unit 11) respectively installed in the plurality of image display apparatuses 100 so that the plurality of semiconductor light sources 20 (light source device 2) are cooled. The cooling device 300a has the same functions and structures as those of the cooling device 300.

The driving methods of the cooling device with the above-mentioned structure are explained as follows. In a first driving method, normally, the cooling device 300 is operated so that the semiconductor light sources 20 (light source device 2 inside the projection unit 11) of the respective image display apparatuses 100 are cooled. In the event of a failure in the cooling device 300, the cooling device 300a is operated so as to carry out cooling operations. That is, the cooling device 300a is utilized as a preliminary device to be used at the time of a failure or the like of the cooling device 300.

A second driving method is a method in which cooling devices for use in cooling are regularly switched so as to be operated. In the case where one of them has a failure in operation, only the cooling device that has no failure is used for cooling.

In this manner, by providing a plurality of cooling devices, it is possible to prevent the cooling operation of the multi-screen display apparatus 1000 from being stopped, even when one of the cooling devices breaks down.

In the modified example 2 of the present preferred embodiment, a structure is prepared in which two cooling devices are used for four image display apparatuses; however, the present invention is not intended to be limited by this structure, and three or more cooling devices may be used.

As described above, in the modified example 2 of the preferred embodiment 1, each of the plurality of cooling devices is thermally connected to the plurality of semiconductor light sources 20 (light source device 2) respectively installed in the plurality of image display apparatuses 100. With this structure, even when one of the cooling devices breaks down, it is possible to prevent the cooling operation of the multi-screen display apparatus 1000 from being stopped.

The structure of the modified example 2 of the present preferred embodiment may be applied to the multi-screen display apparatus 1000A of the modified example 2 of the preferred embodiment 1. That is, a structure may be prepared in which in FIG. 8, to the two branch pipes 13 connected to the cooling device 300, a cooling device 300a is further connected.

In the present invention, within the scope of the invention, embodiments and modified examples of the embodiments may be freely combined with one another, or the respective embodiments and modified examples of the embodiments may be modified or omitted on demand.

The present invention can be utilized as a multi-screen display apparatus which makes it possible to reduce costs for cooling.

While the invention has been shown and described in detail, the foregoing description is in all aspects illustrative and not restrictive. It is therefore understood that numerous modifications and variations can be devised without departing from the scope of the invention

What is claimed is:

1. A multi-screen display apparatus, which utilizes one or more cooling devices, said multi-screen display apparatus comprising: a plurality of image display apparatuses each having one of screens,
said plurality of image display apparatuses forming a multi-screen by a plurality of said screens respectively installed therein, and
each of said image display apparatuses including one of semiconductor light sources for emitting light for use in displaying an image on said multi-screen,
wherein one cooling device of said one or more cooling devices is thermally connected to a plurality of said semiconductor light sources respectively installed in said plurality of image display apparatuses so that the plurality of said semiconductor light sources are cooled.

2. The multi-screen display apparatus according to claim 1, wherein each of said image display apparatuses further comprises one of light valves for modulating an intensity of light emitted by said semiconductor light sources, and said one cooling device is further thermally connected to a plurality of said light valves respectively installed in said plurality of image display apparatuses so that the plurality of said light valves are cooled.

3. The multi-screen display apparatus according to claim 1, wherein said multi-screen display apparatus utilizes a plurality of said cooling devices, and each of said cooling devices is thermally connected to the plurality of said semiconductor light sources so that the plurality of said semiconductor light sources are cooled.
